(19) United States
(12) Patent Application Publication
(10) Pub. No.: US 2023/0127521 A1
(43) Pub. Date: Apr. 27, 2023

(54) SYSTEM FOR MONITORING ARRIVAL OF A VEHICLE AT A GIVEN LOCATION AND ASSOCIATED METHODS

(71) Applicant: ParkHub, Inc., Dallas, TX (US)

(72) Inventor: George Frederick Baker, SR., Dallas, TX (US)

(21) Appl. No.: 17/833,409

(22) Filed: Jun. 6, 2022

Related U.S. Application Data
(63) Continuation of application No. 14/995,148, filed on Jan. 13, 2016, now Pat. No. 11,386,780.

(51) Int. Cl. G08G 1/017; G08G 1/14; G07B 15/02

(52) U.S. Cl. CPC G08G 1/017; G08G 1/144; G08G 1/146; G07B 15/02; G06Q 2240/00

(57) ABSTRACT

A system is for monitoring arrival of a vehicle at a given location. The system includes a server, and a vehicle sensing device. The vehicle sensing device is configured to sense arrival of the vehicle to the given location, and to transmit information about the vehicle to the server in response to sensing arrival of the vehicle to the given location. The server is configured to determine a context of the vehicle based upon the information about the vehicle, and take action based on the context of the vehicle. The system may be installed at parking lots, shipping yards, restaurants, stores, and other locations.

### RELATED APPLICATIONS

This application for patent is related to co-pending application U.S. Ser. No. 14/995,157, filed on Jan. 13, 2016, entitled “System for Monitoring Arrival of a Vehicle at a Given Location and Associated Methods”, the entire disclosure of which is incorporated herein by reference.

### TECHNICAL FIELD

This disclosure related to the field of parking lot monitoring, and, more particularly, to systems and methods for monitoring vehicle arrival and taking action in response thereto.

### BACKGROUND

In many cities, motor vehicles such as cars are the predominant mode of transportation utilized by residents. In some cases, parking lots for motor vehicles are not monitored or attended, and motor vehicles come and go at the direction of their operators. However, in other cases, parking lots are to be monitored and attended. For example, a human attendant physically located at the parking lot may track the inventor of remaining spaces in the parking lot, may direct motor vehicles toward given spaces, and, in the case where the parking lot is a pay lot, may collect money from occupants of the motor vehicles in exchange for provision of a parking space.

Complete management of a parking lot by a human may be undesirable for a variety of reasons. For example, a computing device may be able to more efficiently manage inventory or accept payment, thereby enabling more efficient management of the parking lot, or for quicker payment processing times.

To that end, automated parking lot management systems have been developed. For example, a device may be installed at the entrance of a parking lot that accepts payment from a driver of a motor vehicle, and such device may monitor the number of vehicles in the lot via a counter. While this may provide for a variety of advantages over complete management of the parking lot by a human, the usage of such devices may be confusing to users, or users may incorrectly input information into the device, resulting in incorrect management.

Therefore, further developments in systems for parking lot management are needed.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Described herein is a system is for monitoring arrival of a vehicle at a given location. The system includes a server, and a vehicle sensing device. The vehicle sensing device is configured to sense arrival of the vehicle to the given location, and to transmit information about the vehicle to the server in response to sensing arrival of the vehicle to the given location. The server is configured to determine a context of the vehicle based upon the information about the vehicle, and take action based on the context of the vehicle.

Also described herein is a vehicle sensing system including at least one vehicle sensing device. The at least one vehicle sensing device includes at least one wireless transceiver, at least one vehicle detector, a processor cooperating with the at least one wireless transceiver and at least one vehicle detector. The processor is configured to detect entry of a vehicle into a given area via the at least one vehicle detector, determine information about the vehicle in response to sensing arrival of the vehicle to the given location using at least one of the at least one wireless transceiver and the at least one vehicle detector, and transmit the information about the vehicle to a server using the at least one wireless transceiver.

### BRIEF DESCRIPTION OF THE DRAWINGS

So that the manner in which the above recited features can be understood in detail, a more particular description may be had by reference to embodiments, some of which are illustrated in the appended drawings, wherein like reference numerals denote like elements. It is to be noted, however, that the appended drawings illustrate various embodiments and are therefore not to be considered limiting of its scope, and may admit to other equally effective embodiments.

FIG. 1A is a block diagram of a system for monitoring arrival of vehicles, as installed at a parking lot, in accordance with the present disclosure.

FIG. 1B is a block diagram of a different embodiment of a system for monitoring arrival of vehicles, as installed at a parking lot, in accordance with the present disclosure.

FIG. 1C is a block diagram of a further embodiment of a system for monitoring arrival of vehicles, as installed at a parking lot, in accordance with the present disclosure.

FIG. 1D is a block diagram of an additional embodiment of a system for monitoring arrival of vehicles, as installed at a parking lot, in accordance with the present disclosure.

FIG. 2 is a block diagram of a system for monitoring arrival of vehicles, as installed at a merchant, in accordance with the present disclosure.

FIG. 3 is a block diagram of a system for monitoring arrival of vehicles, as installed at a shipping log, in accordance with the present disclosure.

FIG. 4A is a block diagram of a vehicle detection device such as may be used with the systems shown in FIGS. 1-3.

FIG. 4B is a block diagram of a hub device such as may be used with the systems shown in FIGS. 1-3.

FIG. 5 is a flowchart of a method of monitoring arrival of vehicles, in accordance with the present disclosure.

FIG. 6 is a flowchart of a method of operating the vehicle sensing device of FIG. 4A.

### DETAILED DESCRIPTION

In the following description, numerous details are set forth to provide an understanding of the present disclosure. It will be understood by those skilled in the art, however, that the embodiments of the present disclosure may be practiced without these details and that numerous variations or modifications from the described embodiments may be possible.

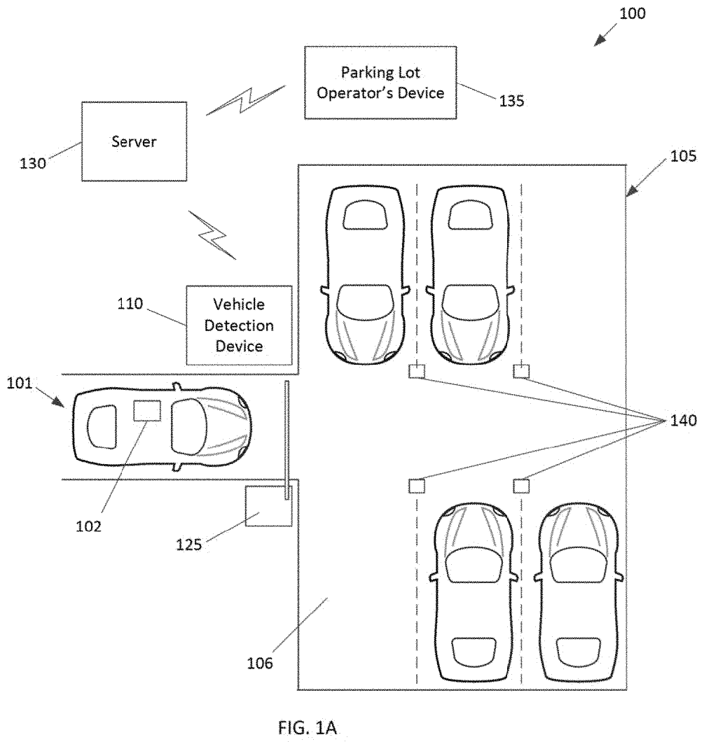

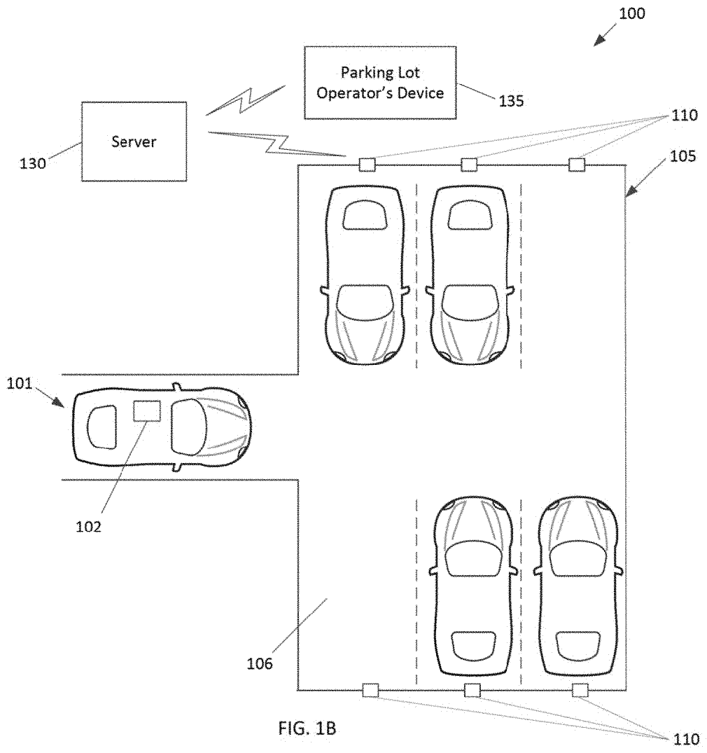

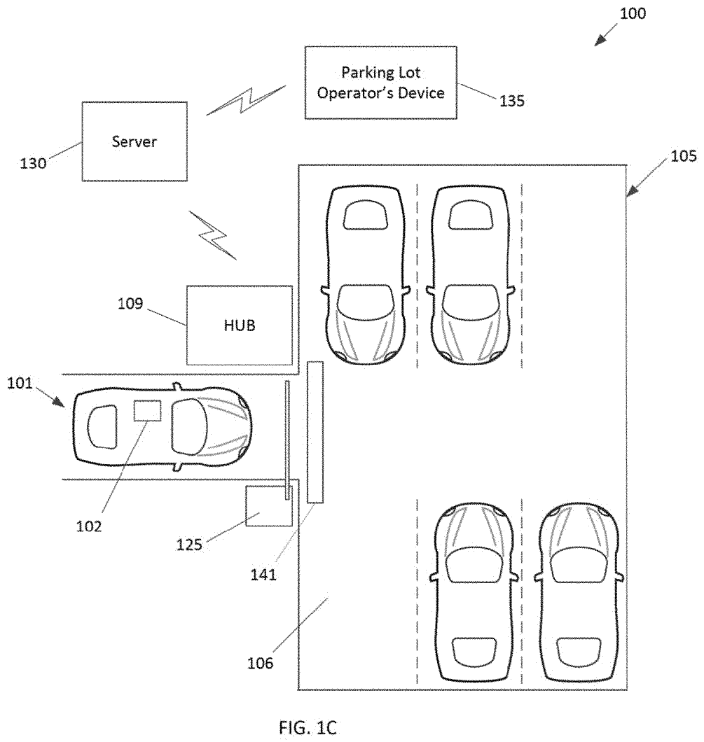

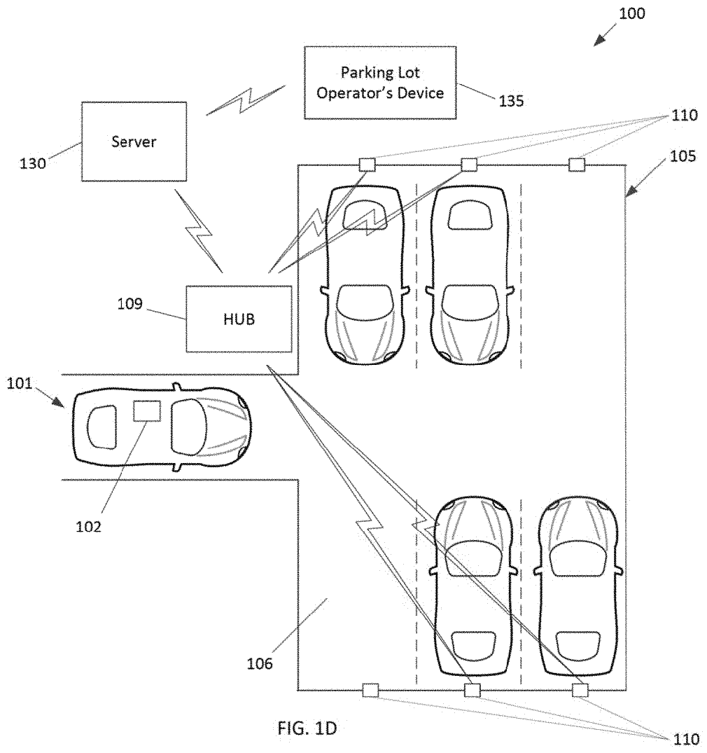

With reference to FIG. 1A, a system 100 for monitoring arrival of vehicles is now described. The system 100 is installed at a parking lot 105, at which motor vehicles, such as cars, trucks, and motorcycles may be parked. A vehicle detection device 100 detects arrival of vehicles and/or entry of vehicles and/or departure of vehicles to or from the parking lot 105. As show, a vehicle 101 is adjacent a motor operated gate 125 selectively that permits vehicles to enter and depart from the parking lot 105. A server 130 is in communication with the vehicle detection device 110 over a network, such as the Internet, and receives data from the vehicle detection device 110. The server 130 processes this data 130, and may then send output to, or prompt for input from, a device of an operator of the parking lot 135, or a device 102 within the vehicle 101. Optional sensors or indicators 140 are installed adjacent parking spots 106.

The device 102 within the vehicle 101 may be a mobile wireless communications device utilized by the driver or passenger of the vehicle 101, such as a smartphone, smartwatch, or tablet, or may be a device integrated within the vehicle 101, such as an infotainment system.

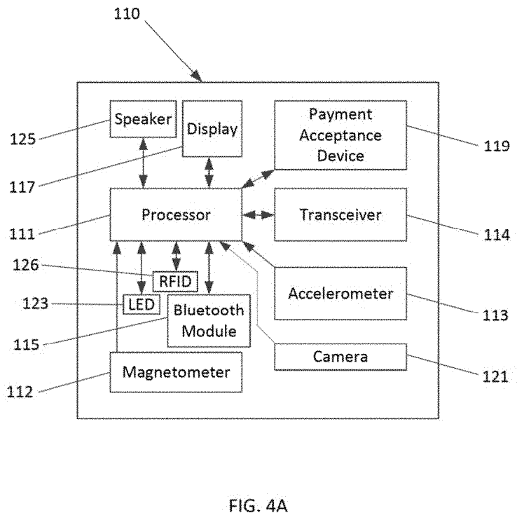

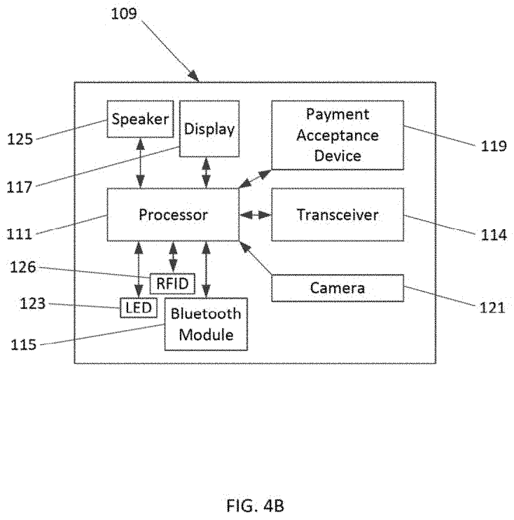

With additional reference to FIG. 4A, further details of the vehicle detection device 110 will now be given. The vehicle detection device 110 includes a processor 111, such as a microprocessor or system on a chip. Coupled to the processor 111 is a magnetometer 112, as well as an accelerometer 113. A Bluetooth module 115 is coupled to the processor 111 for potential communication with the device 102 within the vehicle 101, and a transceiver 114 is coupled to the processor 111 for communication with the server 130 over the wide area network, and/or also with other vehicle detection devices 110 if present, and/or also with the optional sensors 140. A display 117, LED 123, and speaker 125 are coupled to the processor 111 for providing visual or audio output to a user. The display 117, LED 123, and speaker 125 may be utilized for any provided output described below instead of the device 102. A camera 121 is coupled to the processor 111 for taking pictures, such as of the license plate of the vehicle 101, which may be sent to and processed by the server. A RFID reader 126 is coupled to the processor 111 for reading RFID tags associated with the vehicle, such as a toll tag mounted in the vehicle, or RFID tags within the tires of the vehicle.

A payment acceptance device 119 is coupled to the processor 111 for accepting payment from a user. The payment acceptance device 119 may utilize magnetic strip, chip and pin, NFC, or other electronic payment acceptance technologies. In addition, the payment acceptance device 119 may also directly accept hard currency, such as bills and coins. It should be appreciated that in some applications, the payment acceptance device 119 may be part of, or may be, the RFID reader 126.

The magnetometer 112 serves to sense metal in vehicles 101 via a change in the local magnetic field, and can thus detect the presence of vehicles 101. The processor 111 may be able to interpret reading from the magnetometer 112 to estimate the dimensions of the vehicle 101, from which a type or configuration of the vehicle may be inferred (i.e. a vehicle estimated to be a car, whereas a larger vehicle is likely to be a truck).

The accelerometer 113 serves to detect vibrations in multiple axes, such as those caused by a passing vehicle 101, and can therefore be used to determine whether the vehicle 101 is entering or leaving the given area. By logging the magnitude and direction of vibrations detected by the accelerometer 113, the processor 111 can infer both the speed of the vehicle, as well as whether the vehicle is arriving or departing.

Due to the use of the accelerometer 113 and magnetometer 112 for detecting vehicles 101, the vehicle detection device 110 is positioned at the entrance and exit to the parking lot 105, and needs not be driven over by the vehicle 101 in order for detection to occur.

As stated, the RFID reader 126 may read RFID tags associated with the vehicle. Thus, the RFID reader 126 may read a code from the RFID tag, and the code may be a toll tag ID number, or may be a tire identification code. Where the code is a toll tag ID, the information about the vehicle may be the toll tag ID, which may in turn be used for identification of the user by looking up the user's information in a table of toll tag ID's, or in processing payment via the toll tag ID. Where the code is a tire identification code, the information about the vehicle may be the tire identification code, which may in turn be used by the server to determine a make and model of the tires on the vehicle, which may in turn be used to determine the type of vehicle and vehicle configuration, as well as the make and model of the vehicle. Also, the information about the vehicle may include the various measurements taken by the accelerometer 113 and magnetometer 112 as well as the make and model of the tires, which may be used to more accurately determine the type of vehicle and vehicle configuration, as well as the make and model of the vehicle.

As stated above, using the transceiver 114, the vehicle detection device 110 may communicate with other vehicle detection devices 110. In addition, one vehicle detection device 110 may act as a relay for another vehicle detection device 110, transmitting information received therefrom to the server 130, or to the device 102 within the vehicle 101. The transceiver 114 may also be used by the vehicle detection device 110 for communication with a fixed or mobile device used by a parking lot attendant, such as a smartphone, tablet, or pay station.

The processor 111 may also cooperate with additional vehicle detection hardware, such as a pressure sensor for vehicle sensing, allowing retrofitting of the vehicle detection device 110 to existing parking lot management installations. In addition, the processor 111 may also cooperate with hardware, such as RFID readers, that read toll tags or toll passes, and/or Bluetooth connections from which vehicle information may be read, and via which payment for parking may be effectuated.

In some applications, such as that shown in FIG. 1B, rather than the vehicle detection device 110 being at the entrance to the parking lot 105, there is a separate vehicle detection device 110 located in each parking space 106. Each of these vehicle detection devices 110 may have the components as described above and below, and may operate as described above and below. In addition, it should be understood that the various vehicle detection devices 110 may communicate with one another via their transceivers 114, their Bluetooth modules 115, or a combination thereof. This communication may be to relay data to and from the server 130, for example. In addition, the various vehicle detection devices 110 may cooperate using their Bluetooth modules 115 to perform triangulation to determine the position of the vehicle 101 within the parking lot 105, and may then direct the driver of the vehicle 101 to the parking space 106 via the device 102 within the vehicle 101, or via their respective displays 117, LEDs 123, and/or speakers 125.

In other applications, such as that shown in FIG. 1D, rather than directly communicating with the server 130, each vehicle detection device 110 communicates with a hub 109 either wirelessly or over a wire, and the hub 109 in turn communicates with the server 130, serving to pass data to the server 130 from the vehicle detection devices 110, and serving to pass data to the vehicle detection devices 110 from the server 130. It should also be appreciated that the hub 109 may perform any of the functions described above or below as being performed by the vehicle detection device 110.

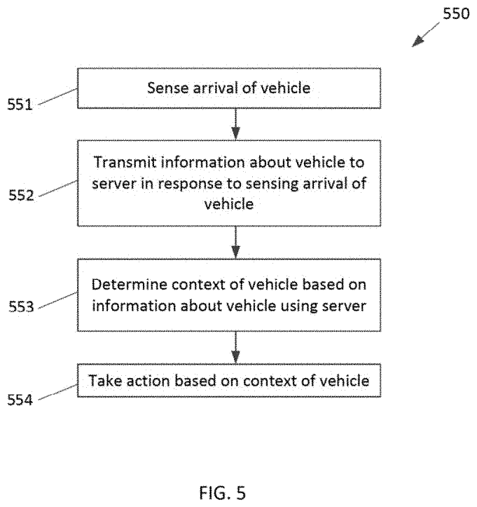

With additional reference to the flowchart 550 of FIG. 5, a method of monitoring vehicle 101 arrival to a given location, such as a parking lot 105, is now described. The vehicle detection device 110, as described above, operates to sense arrival (or departure) of a vehicle 101 (Block 551). The vehicle detection device 110 then sense information about the vehicle 101, and sends it to the server 130 in response to the sensing of arrival or departure (Block 552). The information about the vehicle may be sensed via the magnetometer 112 and accelerometer 113, and/or may be sensed via interaction with the device 102 within the vehicle 101 via the Bluetooth module 115, or via the transceiver 114.

Next, the server 130 determines a context of the vehicle 101 based on the information received from the vehicle detection device 110 (Block 553). Thereafter, the server 130 takes at least one action based on the context of the vehicle 101 (Block 554).

Through sensing different types of information about the vehicle 101, through determining different contexts, and through taking different actions, the system 100 may be used in a wide variety of applications. For example, the application shown in FIG. 1A is that where the system 100 is installed at a parking lot 105.

A first parking related application is where a driver of the vehicle 101 has prepaid for parking via the device 102. When the vehicle 101 arrives to the parking lot 105, the vehicle detection device 110 operates to read the prepayment (or voucher) information from the device 102, or serves to identify the vehicle 101 via the device 102 and then query the server 130 for the prepayment or voucher information. If the prepayment or voucher is valid (i.e. has been properly paid for the correct amount, and/or if it is an authorized time of day, date, or day of the week), the vehicle detection device 110 or server 130 instructs the gate 125 to open, and updated parking lot inventory information is sent to the parking lot operator's device 135.

If no prepayment is present, or if the prepayment or voucher is not valid for the present time, the vehicle detection device 110 may, either on its own via its display 117, LED 123, and speaker 125, or via the device 102 in the vehicle 101, demand payment for the right to park the vehicle 101 in the parking lot 105. If, within a given amount of time, the payment is not received (from either the device 102, or in pieces from multiple devices 102, or via the payment acceptance device 119) and the vehicle 101 has not left the parking lot, the vehicle detection device 110, either on its own or via the server 130, may notify the parking lot operator's device 135 that the vehicle 101 is parked in the parking lot 105 without having paid for the right to do so.

In a second parking related application, the vehicle detection device 110 serves to detect the number of devices 102 in the vehicle 101, and transmits that information to the server. Since the majority of adults carry a smartphone in today's world, from this number of devices 102 in the vehicle 101, the server 130 can estimate the number of people in the vehicle 101, and may transmit this data to the parking lot operator's device 135, may save this data for future analytics, or may transmit this data to other devices, such as those within a venue adjacent the parking lot 105.

In a third parking related application, the vehicle detection device 110 serves to read user identity information from the device 102 in the vehicle, or to request user identity information associated with the device 102 from the server 130. Then, the server 130 can notify the parking lot operator or venue that the user matching the user identity information has arrived. Therefore, the parking lot operator or venue can prepare for the arrival of that specific user.

As an example, the specific user may have reserved a given parking space 106, and the parking lot operator may manually (via a human attendant) direct the vehicle 101 to park in the parking space 106, or the server 130 may direct the vehicle 101 to park in the parking space 106 via displays incorporated with the sensors 140, or via the display 117, LED 123, and/or speaker 125. In addition, in some applications, the sensors 140 may report to the parking lot operator, the vehicle detection device 110, or the server 130 which spaces are occupied. This functionality may also be performed by the vehicle detection device 110. If the vehicle detection device 110, via the sensors 140 or on its own, determines that the reserved space 106 has been improperly occupied (i.e. the space 106 is occupied, but the vehicle detection device 110 has not detected the device 102 of the specific user), the vehicle detection device 110 may directly or via the server 130 notify the parking lot operator's device 135 that the parking space 106 is occupied by an unauthorized vehicle.

In any such parking applications wherein payment is collected for the parking space 106, the vehicle detection device 110 may determine both an arrival time and a departure time of the vehicle 101, and the payment amount may be based upon the length of time between the arrival time and departure time. The payment amount may be additional or alternatively be based upon the time of day, date, or day of week of the arrival time and/or departure time—for example the payment may be greater on a Saturday than on a Tuesday, or may be less at 2:00 AM than at 9:00 AM. In addition, the payment amount may be dependent upon the weight, type, or configuration of the vehicle 101 (e.g. vehicle size, vehicle weight, vehicle body style, etc), as determined based on readings from the magnetometer 112 and/or accelerometer 113.

In some cases, the vehicle 101 may be authorized to park in the parking lot 105 at the time of parking, but may at a later point in time, before departure, become no longer authorized. For example, the parking lot 105 may be operated by a municipality, and may need to be emptied for street cleaning, trash pickup, etc. In such cases, the server 130 may notify the parking lot operator's device 135 (and thus the municipality's device) that certain vehicles have not yet departed. The municipality can then take appropriate action. In some cases, such notification may additional or alternatively be sent to the device 102.

Another parking application may be where the parking lot 105 is a valet parking lot. The vehicle detection device 110 may this record a unique identifier for the vehicle when it entered the parking lot 105, and thus unique identifier may be transmitted, via the server 130 or directly, to the device 102. A user may request retrieval of the vehicle 101 via provided input to the device 102.

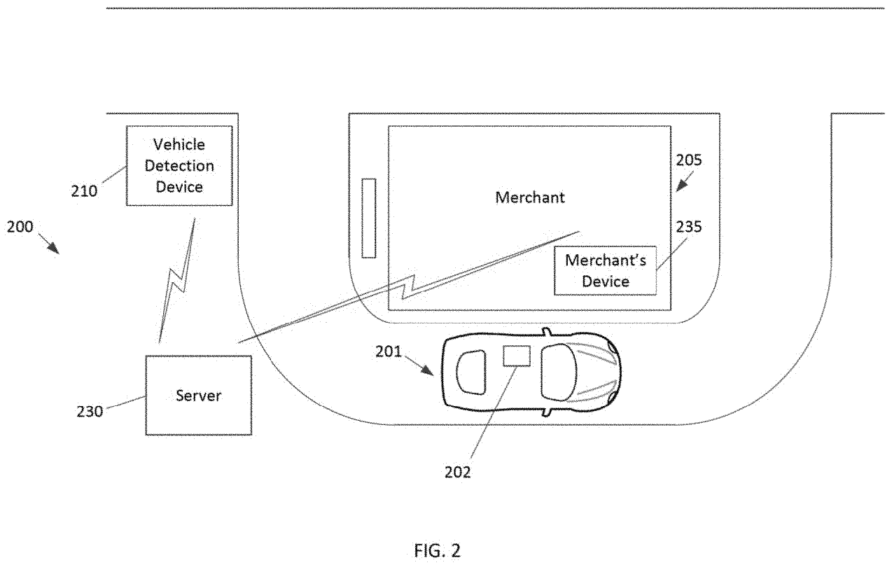

Another application for the system 200 in which the system 200 is employed at a merchant is now described with additional reference to FIG. 2. Here, the parking lot 205 is a parking lot for a merchant, such as a restaurant, and 205 may be a drive through lane instead of a parking lot. The vehicle detection device 210 can detect when the vehicle 201 arrives at the merchant, and can read the identify of a user from the device 202, or request an identity of the user from the server 230 based on information received from the device 202. The server 230 may then send the identity of the user to the merchant's device 235, which may retrieve order information for the user. In some applications, the server 230 may have the order information for the user, and may pass the order information along to the merchant's device 235. In yet another application, the vehicle detection device 210 may cause the device 202 to prompt the user to enter an order. The user's order may then be transmitted to a device inside the Merchant's business wherein it is prepared and delivered to the user. In the case of 205 being a drive through lane, the system 200 may compute the time required to prepare the user's order and, comparing such time to the time required to prepare other users' orders within the drive through lane, may direct the Merchant's employees to prepare orders in a sequence different from the sequence of vehicles in the drive through queue in an effort to minimize user wait times and maximize efficiency.

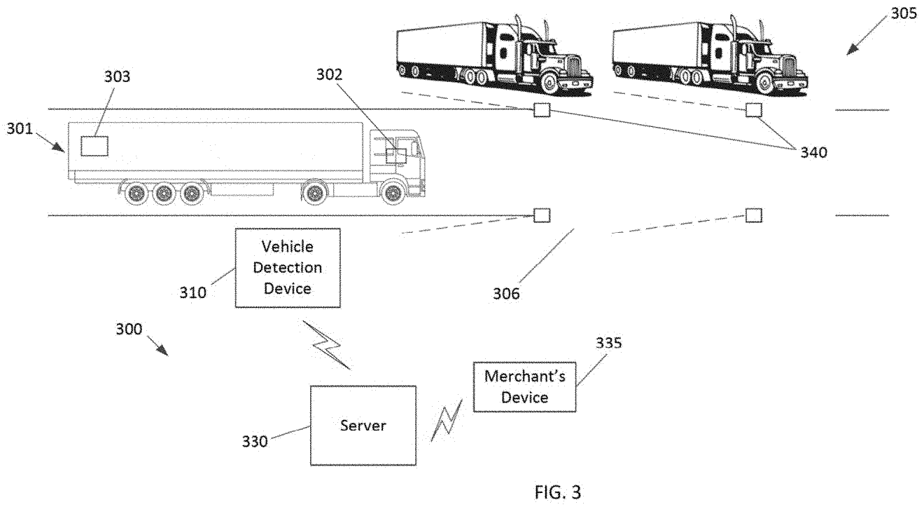

Yet another application for the system 300 in which the system 300 is employed at a shipping yard is now described with additional reference to FIG. 3. Here, the parking lot 305 is for trucks 301 at a shipping yard. The vehicle detection system 310 may retrieve a shipping manifest from the device 302, server 330, or shipping yard's device 335, and pass the shipping manifest along to any such device. The server 330 or shipping yard's device 335, knowing that the shipment having that shipping manifest has arrived, may notify the owner of the cargo. The server 330 may, either directly or via the vehicle detection system 310, notify the device 302 or the sensors 306 to direct the driver where to park the truck.

Additional sensors 303 may be placed in the cargo containers carried by the trucks 301, and these sensors may detect when the cargo container is being moved (for example, from a 301 to storage), and transmit that data to the server 330 via the vehicle detection device 310. The server 330 may then report that data to the shipping yard's device 335.

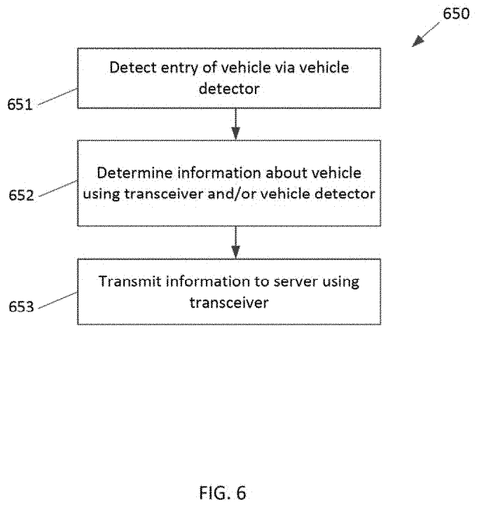

Further details of the vehicle sensing system 100 and vehicle sensing device 110 will now be given with reference to FIGS. 4 and 6. A method of operating the vehicle sensing device 110, described with reference to flowchart 650, includes detecting entry of the vehicle to the given area via the vehicle detector (e.g. magnetometer 112, accelerometer 113, etc) at Block 651. Thereafter, the method includes determining information about the vehicle, in response to sensing arrival of the vehicle to the given location, using the wireless transceiver 114 and/or the vehicle detector (e.g. magnetometer 112, accelerometer 113, etc) at Block 652. Then, the method continued with transmitting information to the server using the transceiver 114 at Block 653.

In some instances, the processor 111 may transmit an application trigger to cause the device within the vehicle (e.g. smartphone, infotainment system, etc) to launch an application. This application may prompt the user for payment, provide the user with notice that they are authorized or not authorized, provide the user with information about where to park, where to pick up cargo, or where to drop off cargo, provide the user with information about valet parking (such as price), or provide the user with information about an order from a merchant.

In some applications, for example such as the one shown in FIG. 1C, rather than a vehicle sensing device performing the above steps, a hub 109 works in accordance with a counting device 141 to perform the above functions. The hub 109 contains similar components to the vehicle sensing device described above, as is apparent from FIG. 4B, and has similar functionality to the vehicle sensing device as well, with the exception being that it lacks a magnetometer and accelerometer, and instead determines arrival and departure of vehicles via triggering of the counting device 141 by the weight of the vehicles driving over the counting device 141. It should be appreciated that the hub 109 may actually be a portable wireless electronic device, such as a smartphone or tablet.

Although the preceding description has been described herein with reference to particular means, materials and embodiments, it is not intended to be limited to the particulars disclosed herein; rather, it extends to all functionally equivalent structures, methods, and uses, such as are within the scope of the appended claims.

1. A vehicle sensing system, comprising:
at least one vehicle sensing device comprising:
at least one wireless transceiver;
at least one vehicle detector;
a processor cooperating with the at least one wireless transceiver and at least one vehicle detector and configured to:
detect entry of a vehicle into a given area via the at least one vehicle detector;
determine information about the vehicle in response to sensing arrival of the vehicle to the given location using at least one of the at least one wireless transceiver and the at least one vehicle detector;
transmit the information about the vehicle to a server using the at least one wireless transceiver.

2. The vehicle sensing system of claim 1, wherein the at least one wireless transceiver comprises a wireless network transceiver and a Bluetooth receiver; and wherein the processor is also configured to transmit an application trigger via the Bluetooth receiver.

3. The vehicle sensing system off claim 1, wherein the at least one vehicle sensing device comprises a plurality of vehicle sensing devices each having the at least one transceiver, the at least one vehicle detector, and the processor; wherein the at least one transceiver of each vehicle sensing device comprises a wireless network transceiver and a Bluetooth transceiver; and wherein the processors of the plurality of vehicle sensing devices are configured to cooperate, using their respective Bluetooth transceivers, to determine a position of a wireless device in wireless communication with at least one of the vehicle sensing devices via Bluetooth communications.

4. The vehicle sensing system of claim 3, wherein each vehicle device further comprises an output device; and wherein the processors of the plurality of vehicle sensing devices are configured to cooperate to direct a user of the wireless device to an authorized parking space via their respective output devices.

5. The vehicle sensing system of claim 3, wherein the processors of the plurality of vehicle sensing devices cooperate to determine the position of the wireless device using Bluetooth signal triangulation.

6. The vehicle sensing system of claim 1, wherein the at least one vehicle detector comprises an accelerometer; and wherein the processor is further configured to determine whether the vehicle is entering the given area or leaving the given area based on a series of vibrations recorded by the accelerometer

7. The vehicle sensing system of claim 1, wherein the at least one vehicle detector comprises a magnetometer; and wherein the information about the vehicle determined by the processor is at least one of a vehicle size, vehicle weight, and vehicle configuration estimated based on the magnetometer.

8. The vehicle sensing system of claim 1, wherein the at least one vehicle detector comprises an RFID reader; and wherein the information about the vehicle determined by the processor is a code associated with tires used by the vehicle.

9. The vehicle sensing system of claim 8, wherein the processor is also configured to accept payment from the user via the RFID reader.

10. The vehicle sensing system of claim 1, wherein the at least one transceiver comprises a wireless network transceiver and a Bluetooth receiver; and wherein the information about the vehicle determined by the processor is a number of Bluetooth enabled devices within the vehicle as detected by the Bluetooth receiver.

11. The vehicle sensing system of claim 1, wherein the at least one vehicle sensing device further comprises an output device coupled to the processor; wherein the processor is also configured to, after transmitting the information about the vehicle to the server, receive a payment prompt from the server via the at least one wireless transceiver and present the payment prompt to a user via the output device

12. The vehicle sensing system of claim 11, wherein the at least one vehicle sensing device further comprises a payment acceptance device coupled to the processor; and wherein the processor is also configured to, after presenting the payment prompt to the user via the output device, accept payment from the user via the payment acceptance device.

13. The vehicle sensing system of claim 11, wherein the processor is also configured to, if payment has not been received in a given amount of time after presenting the payment prompt to the user, determine whether the vehicle has left the given location via the at least one vehicle detector, and notify a parking lot operator about theft if the vehicle has not left the given location.

14. The vehicle sensing system of claim 1, wherein the processor is also configured to, via the at least one vehicle detector, determine which parking space at the given location the vehicle is parked in, transmit information about that parking space to the server via the at least one wireless transceiver.

15. The vehicle sensing system of claim 14, wherein the at least one vehicle sensing device further comprises an output device coupled to the processor; wherein the processor is also configured to receive authorization for the vehicle to be parked in the parking space via the wireless transceiver, in response to transmission of the information about the parking space, and to communicate the authorization for the vehicle to be parked in the space to a user via the output device.

16. The vehicle sensing system of claim 14, wherein the at least one vehicle sensing device further comprises an output device coupled to the processor; wherein the processor is also configured to receive a lack of authorization for the vehicle to be parked in the parking space via the wireless transceiver, in response to transmission of the information about the parking space, and to communicate the lack of authorization for the vehicle to be parked in the space to a user via the output device.

17. The vehicle sensing system of claim 16, wherein the processor is also configured to, via the at least one vehicle detector, determine whether the vehicle has left the parking space within a given amount of time after communication of the lack of authorization, and to notify a parking lot operator about theft if the vehicle has not left the given location.

18. The vehicle sensing system of claim 1, wherein the processor is also configured to, via the at least one vehicle detector, determine an entry time of the vehicle into a given parking space and an exit time of the vehicle from the given parking space, and transmit the entry time and exit time to the server.

19. The vehicle sensing system of claim 18, wherein the processor is also configured to calculate a payment amount based on the entry time and the exit time.

20. A vehicle sensing system, comprising:
a plurality of sensing devices each comprising:
a wireless network transceiver;
a Bluetooth transceiver;
at least one vehicle detector;
a processor coupled to the wireless network transceiver, the Bluetooth transceiver, and the at least one vehicle detector, the processor configured to cooperate with respective processors of other sensing devices to:
detect entry of a vehicle into a given area via the at least one vehicle detector;
determine information about the vehicle in response to sensing arrival of the vehicle to the given location using at least one of the at least one wireless transceiver and the at least one vehicle detector;
transmit the information about the vehicle to a server using the at least one wireless transceiver.

21. (canceled)

22. (canceled)
